(19) United States
(12) Patent Application Publication
(10) Pub. No.: US 2016/0219828 A1
(43) Pub. Date: Aug. 4, 2016

(54) Litter box assembly

(71) Applicant: Daniel Goerz, Dallas, TX (US)

(72) Inventor: Daniel Goerz, Dallas, TX (US)

(21) Appl. No.: 14/613,839

(22) Filed: Feb. 4, 2015

(51) Int. Cl. A01K 1/01

(52) U.S. Cl. CPC A01K 1/0114; A01K 1/011

(57) ABSTRACT

A litter box assembly for holding cat litter may include a first litter box and a second litter box being stackable with the first litter box. The first litter box may include a first bottom having an downward extending first disk with an aperture, and the second litter box may include a second bottom having a downward extending second disk with an aperture. The first disk may not align with the second disk while the first litter box is stacked with the second litter box.

### FIELD OF THE INVENTION

The present invention relates to a pet waste box assembly including an a plurality of uniformly-shaped stackable boxes which are used in sequential order to clean pet waste

### BACKGROUND

Keeping pets is a never-ending task, requiring one to constantly feed the pets and clean their waste. For those that raise, breed, or board cats, their responsibilities also include maintaining a litter box. Such maintenance ensures that the cat is provided a healthy and sanitary location for its excrement. This maintenance includes periodic cleaning and changing of the litter in the litter box. Typically, the cat owner must sift through the litter to remove the solid clumps of urine and solid waste products with a handheld scoop. However, the scooping device often breaks up the clumps so that they are difficult to remove, thus causing waste material to remain in the sifted litter. Such waste material causes odors and unsanitary conditions. When sifting waste products form in a cat box, the pet owner must sift through the entire amount of litter in the cat box to ensure that all waste is removed. This is time consuming and may be difficult for the elderly or disabled to perform on a repeating periodic basis. Moreover, it is often easy to lose track of when the litter should be replaced entirely. Accordingly, there exists a need for a device by which cat litter boxes can be more easily cleaned and maintained without the disadvantages as mentioned above. The development of the instant invention fulfills this need. (See Patent Application 2012/0325159)

There are several different types of litter boxes. By way of example, the following patents are representative of the state of the art.

U.S. Pat. No. 3,796,188 to Bradstreet discloses a reusable, sanitary pet lavatory comprising a pair of identical nested box-like receptacles with each of the receptacles having a screened or perforated plate positioned above a slideable floor member. In use, the upper receptacle, which contains pet litter, nests within and is supported by the lower receptacle; the floor members located in each receptacle being in a closed position with respect to the perforated plate. The closed floor member in the upper receptacle prevents the pet litter, in which pet excrement is deposited, from falling into the lower receptacle until separation of the excrement from the litter is desired. The apertures perforated in the plate member are sized to screen out the solid pet excrement while permitting the separated pet litter to pass through to the lower receptacle for collection when the slide in the upper receptacle is opened. The components are interchangeable so that each receptacle can serve as either the separating or collecting means for the lavatory.

U.S. Pat. No. 3,809,013 to Rigney et al. discloses an insert for placement in an open, self-supporting tray for use as an animal litter box. A number of disposable screens are stacked on top of each other, constructed of flat, thin flexible material such as paper or plastic film, include a plurality of holes at their center portion and are placed in the tray so that walls of the tray fold the screens into a receptacle. Means is provided for closing the holes in the screens to prevent articles from entering the holes and for opening them upon lifting a screen from the stack. To change the liner and dispose of waste, the top liner is lifted whereby litter sifts through the holes onto the remaining screens for reuse while the liner and the waste thereon are discarded.

U.S. Pat. No. 3,908,597 to Taylor discloses a litter box for pets which has a central receptacle divided by a partition into dual compartments that may alternately serve as upper and lower litter areas. The receptacle ends have identical covers and a pair of screened trays are positioned within the chambers. The partition is removably retained within the receptacle which has a side wall portion formed with an entrance slot. To switch or change the litter areas, the partition may be selectively withdrawn from the receptacle through the slot. Absorbent material is then permitted to fall from the upper chamber to the lower chamber as litter waste from the pet is retained on the upper screened tray. Thereafter the upper screened tray is emptied and returned and the partition is inserted back through the entrance slot. The entire litter box is inverted or flipped over so that the other screened tray, previously on the bottom but now on the top of the partition, may be used for the litter area.

U.S. Pat. No. 4,217,857 to Geddie discloses an improved pet relief station for the receiving of pet excrement. The relief station comprises a screen pan having a screen portion, and a pair of receiving pans that are alternatively stackable one in the other. The screen pan is placed in one of the receiving pans, and this pan is in turn stacked in the other receiving pan. Pet litter is disposed in the screen pan to cover the screen portion thereof. Once pet solids have been deposited on the pet litter, the solids are removed by lifting the screen pan, sifting the pet litter which separates the pet solids onto the screen portion, and disposing of the solids. Immediate reassembly of the relief station is afforded by separating the receiving pans, positioning the screen pan in the empty receiving pan, and then pouring the litter over the screen portion of the screen pan. The receiving pans are then restacked.

U.S. Pat. No. 4,505,226 to Carlson discloses a litter-cleaning animal litter box which is comprised of two substantially identical nestably stacked animal litter receptacles, with aperture means at their bottoms sized to permit the passage of litter but retain solid waste. A false bottom, to which wetted litter adheres, is fitted into each receptacle. Litter is placed into the upper receptacle-false bottom combination. A retaining edge that keeps the cat from scratching litter from the box when instinctively digging and covering is press fitted onto the peripheral shoulder of the upper receptacle. The upper receptacle-false bottom combination serves as a litter and waste holding means. The lower receptacle-false bottom combination serves as a strained litter receiving means. When operated, the retaining edge is removed and set aside. The false bottom in the upper receptacle is removed along with the adhering wetted litter. The false bottom is vibrated, scraped, wiped, washed, or otherwise mechanically worked in order to remove the adhering litter for disposal. The upper receptacle is then moved back and forth, and to and fro to make the litter fall through the receptacle's aperture means into the lower receptacle-false bottom combination. Solid waste is retained in the upper receptacle and discarded. The cleaned false bottom is replaced into the cleaned receptacle. The receptacle-false bottom combination now containing the cleaned litter is nestably stacked into the reassembled just-cleaned combination. The retaining edge is pressed onto the peripheral shoulder of the now upper receptacle, litter added to replace that discarded during cleaning, and the litter-cleaning animal litter box is again ready for service.

U.S. Pat. No. 5,325,815 to Gumpesberger discloses a device for sifting a siftable material and which comprises at least three nestable trays. The trays are stacked to form a vertically stacked array. Each tray has a base having a plurality of ribs defining a plurality of openings sized to permit the material to pass through, while preventing passage of large objects. The openings of each tray are arranged in a pre-set pattern so that pairs of trays may be nested together with the openings of one tray blocked by the ribs of the other. The trays may be identical with the openings arranged asymmetrically in the base of each tray, so that the necessary interference or blocking is achieved by rotating each tray relative to the adjacent tray. Alternatively, the openings can be symmetrically located with two different trays being provided, having complementary patterns of openings. The stacked array of trays can be configured as a cat litter container, or used for sifting a variety of the material.

U.S. Pat. No. 5,517,947 to Christman discloses a sifting litter-box utilizing two identical litter trays, each with sieve openings integrated into one sidewall. The trays are nested so that their respective integrated sieve openings are on diametrically opposed sides of the nested pair of trays, thereby the backwall of the lower tray closes off the sieve openings of the upper tray when nested one atop the other. The litter occupying only the top tray (8a) is, after use, sifted into the bottom tray by lifting the top tray (8a) and tilting its contents toward its sieve-wall allowing the reusable litter to pass through its sieve openings and form a static pile of sifted reusable litter at the backwall of the bottom tray. Feces and urine clumps are retained in the top tray which in then emptied. The emptied top tray is sanitized and is nested as the bottom tray, with the former bottom tray with the reusable litter pile becoming the top tray and once again the sieve-wall of the upper tray is closed off by the backwall of the lower tray. The nested tray array is then shaken to level the sifted litter pile readying the sifting litter-box for reuse.

U.S. Pat. No. 5,799,610 to Poulos discloses a litter box assembly for pets that includes two identical, stackable litter boxes each having a bottom with a pattern of openings and pointed, raised projections. A track extends around the bottom of each box to hold a plate with defines mating apertures and slides back and forth in the track to, respectively, align the openings and close off the openings. A handle on each box attaches to the plate and may be moved to the open position to allow unclumped litter to flow into the box stacked below. The clumped waste is held off the bottom of the box on the raised projections for disposal by dumping. The lower box containing the filtered litter is moved to the top position of the stack to be ready for use.

U.S. Pat. No. 6,745,719 to Howerton discloses a litter sifting device for use with an existing litter box. The device has a first screen assembly and a second screen assembly, each having a screen, two handles, and two side walls. The screen has a mesh size which is small enough to permit unused litter to fall back into the litter box, while retaining soiled litter, when the device is removed from the litter box for appropriate disposal of the waste material. For smaller litter boxes, the first screen assembly may be used alone. For larger litter boxes, the second screen assembly may be used in conjunction with the first screen assembly. The first screen assembly is telescopically positionable within the second screen assembly, thereby allowing a range of possible lengths for the litter sifting device. The handles permit lifting the litter sifting device from the litter box without a user coming into contact with the soiled litter.

### SUMMARY

A litter box assembly for holding cat litter may include a first litter box and a second litter box being stackable with the first litter box.

The first litter box may include a first bottom having an downward extending first disk with an aperture, and the second litter box may include a second bottom having a downward extending second disk with an aperture.

The first disk may not align with the second disk while the first litter box is stacked with the second litter box.

The litter box assembly may include a first pattern of a plurality of first disks.

The litter box assembly may include a second pattern of a plurality of second disks.

The litter box assembly may include a third litter box stackable with the first litter box and the second litter box.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a perspective view of a litter box assembly of the present invention;

FIG. 2 illustrates a bottom view of the litter box assembly of the present invention;

FIG. 3 illustrates a bottom view of another embodiment of the litter box assembly of the present invention;

FIG. 4 illustrates a bottom view of another embodiment of the litter box of the present invention;

FIG. 5 illustrates a bottom view of another embodiment of the litter box of the present invention;

FIG. 6 illustrates a top view of the disk of the present invention;

FIG. 7 illustrates a side view of the disk of the present invention;

FIG. 8 illustrates a bottom view of the disk of the present invention.

### DETAILED DESCRIPTION

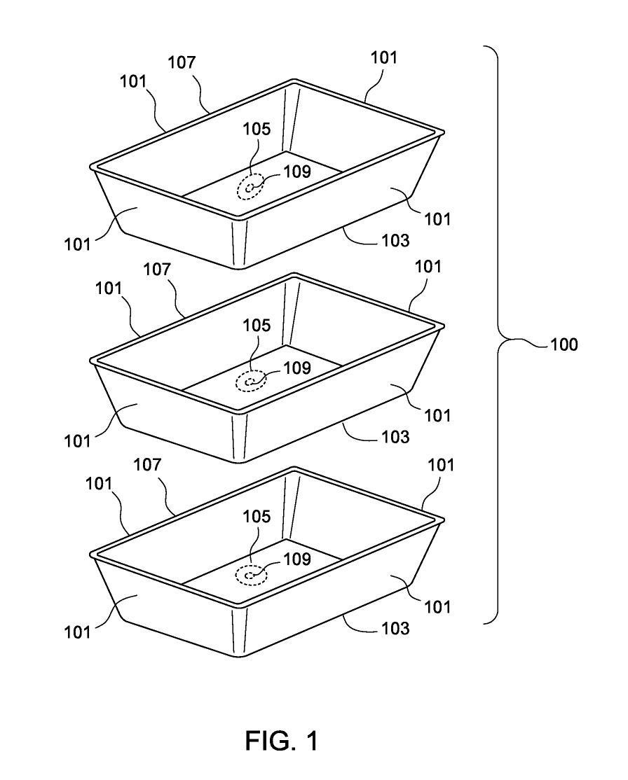

FIG. 1 illustrates a litter box assembly 100 which may include a plurality of uniformly-shaped stackable boxes 107 which are used in sequential order to clean pet waste. More specifically, a litter box assembly 100 and all is useful in containment and removal of cat litter and waste. Each stackable/nestable litter box 107 includes an open top, tapered sides 101, a substantially flat bottom 103, and a cylinder/disk 105 which may be formed in the bottom 103 having openings 109 or grates in the bottom which may extend through the bottom 103 in order that the cat litter which does not include waste is allowed to flow to the next sequential litter box 107. The sides of the stackable box may be substantially perpendicular to the bottom 103, and during use, the user stacks the boxes 107 to gather such that the cylinder/disk 105 of one box 107 does not overlap with a cylinder/disk 105 of another box 107 such that when the boxes 107 are stacked, the litter does not flow from one litter box 107 to another litter box 107. The bottom surface 111 interacts with the top surface of the bottom 103 to provide a seal around the bottom surface 111 in order to prevent the litter from flowing into the litter box 107. When the top litter box 107 is lifted off the middle litter box 107, the seal around the bottom surface 111 is removed, allowing the litter to flow from the top litter box 107 to the middle litter box 107. The opening 109 may be sufficiently sized in order to prevent contaminated litter from leaving the top litter box 107 and allowing the uncontaminated litter to flow to the middle litter box 107. The contaminated litter from the top litter box 107 can be easily disposed with or without the aid of a shovel or scooping device (not shown). The previously top litter box 107 is placed underneath the remaining two litter boxes 107 allowing the previous middle litter box 107 to become the top litter box 107, and the previous bottom litter box 107 becomes the middle litter box 107. Additional litter boxes may be employed. The cylinder/disk 105 may include an open top, a side surface 113 which may be sloping or perpendicular to the bottom 103 and which may extend around the periphery of the cylinder/disk 105 and a bottom surface 111 which may connect to the side surface 113. An opening 109 may extend through the bottom of the cylinder/disk 105 to allow the waste free kitty litter to flow through the litter box 107. The opening 109 are alternated such that a solid bottom is arranged below the opening 105 of each box except the bottom one. Litter is deposited into the top box 107 with the opening 105 in the top box being sealed by a solid portion of the next succeeding box. To use, the user simply picks up the top box and easily separates the pet waste from unused litter by shaking the top box in a back-and-forth or side-to-side manner to cause the unused litter to fall through the opening 105 into the box below. Waste is maintained within the top box which is then dumped into an appropriate waste receptacle. The top box is then positioned beneath the plurality of stacked boxes.

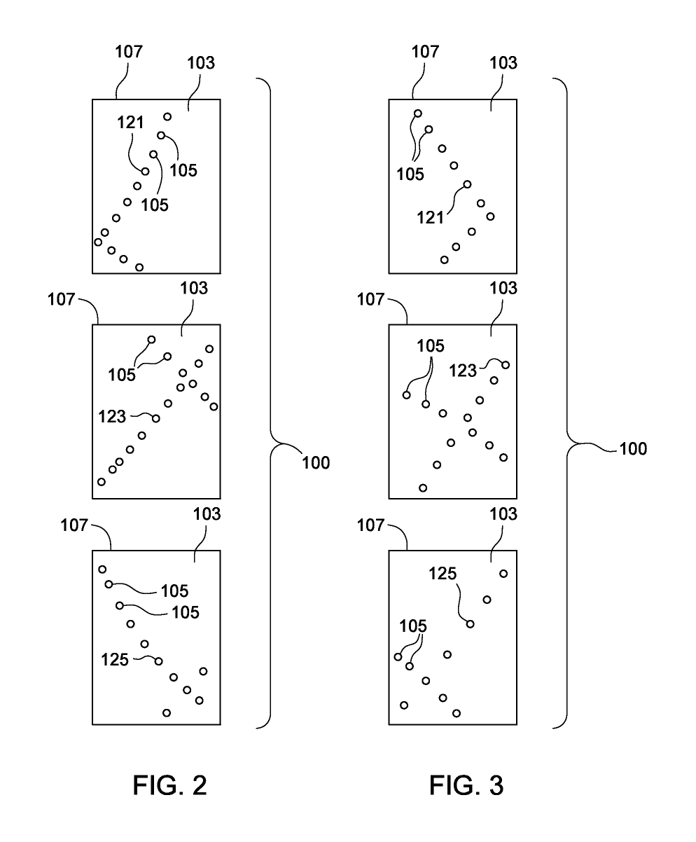

FIG. 2 illustrates a bottom view of the litter box assembly 100 and illustrates a first pattern 121 of disk 105, a second pattern 123 of disk 105 and a third pattern 125 of disk 105. The first pattern 121 does not intersect or overlap the second pattern 123 or the third pattern 125; the second pattern 123 does not intersect or overlap the first pattern 121 or the third pattern 125; and the third pattern 125 does not intersect or overlap the first pattern 121 or second pattern 123.

FIG. 3 illustrates another bottom view of the litter box assembly 100 and illustrates another first pattern 121 of disk 105, another second pattern 123 of disk 105 and another third pattern 125 of disk 105. The first pattern 121 does not intersect or overlap the second pattern 123 or the third pattern 125; the second pattern 123 does not intersect or overlap the first pattern 121 or the third pattern 125; and the third pattern 125 does not intersect or overlap the first pattern 121 or second pattern 123.

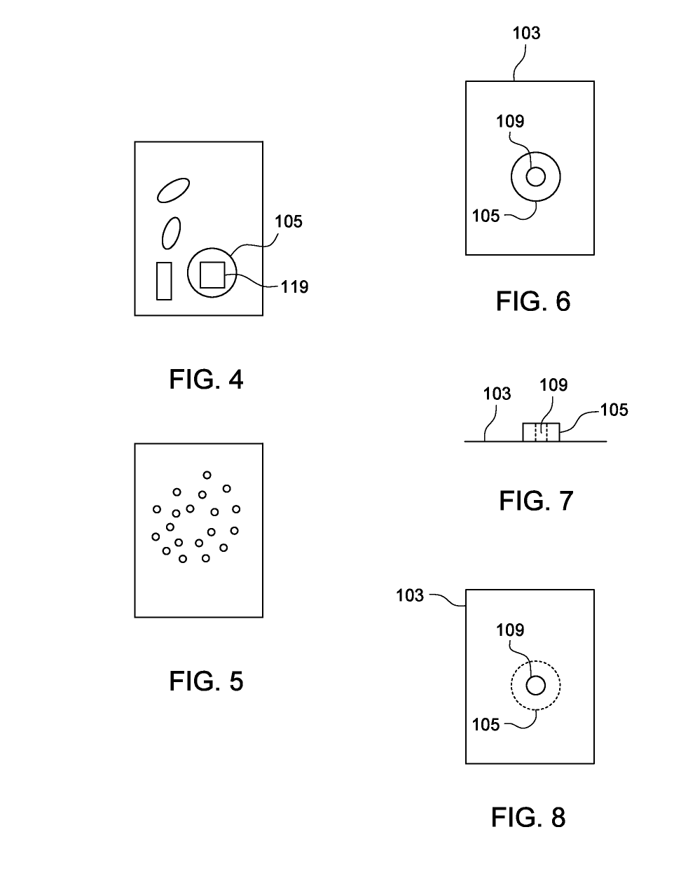

FIG. 4 illustrates another bottom view of the litter box assembly 100 and illustrates that the cylinder/disk 105 may include a rectangular opening 110.

FIG. 5 illustrates another bottom view of the litter box assembly 100 and illustrates that the cylinder/disk 105 may be formed in a spiral pattern.

FIG. 6 illustrates a bottom view of a portion of the bottom 103 and illustrates the cylinder/disk 105 and the central opening 109.

FIG. 7 illustrates a side view of a portion of the bottom 103 and illustrates the cylinder/disk 105 and the central opening 109.

FIG. 8 illustrates a top view of a portion of the bottom 103 and illustrates the cylinder/disk 105 and the central opening 109.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A litter box assembly for holding cat litter, comprising:
a first litter box;
a second litter box being stackable with the first litter box;
wherein the first litter box includes a first bottom having an downward extending first disk with an aperture;
wherein the second litter box includes a second bottom having a downward extending second disk with an aperture;
wherein the first disk does not align with the second disk while the first litter box is stacked with the second litter box.

2) A litter box assembly for holding cat litter as in claim 1, wherein the litter box assembly includes a first pattern of a plurality of first disks.

3) A litter box assembly for holding cat litter as in claim 1, wherein the litter box assembly includes a second pattern of a plurality of second disks.

4) A litter box assembly for holding cat litter as in claim 1, where in the litter box assembly includes a third litter box stackable with the first litter box and the second litter box.
